(19) United States
(12) Patent Application Publication
(10) Pub. No.: US 2005/0030900 A1
(43) Pub. Date: Feb. 10, 2005

(54) Method, receiving device and transmitting device for determining the fastest message path without clock synchronisation

(76) Inventors: Hanns-Jurgen Schwarzbauer, Grobenzell (DE); Michael Tuxen, Oldenburg (DE)

Correspondence Address: Siemens Corporation;Intellectual Property Department, 170 Wood Avenue South, Iselin, NJ, 08830, US

(21) Appl. No.: 10/494,552

(22) PCT Filed: Oct. 1, 2002
(86) PCT No.: PCT/EP02/11013

(30) Foreign Application Priority Data
Oct. 31, 2001 (EP) 01126009.8

(51) Int. Cl. H04J 1/16

(52) U.S. Cl. 370/238

(57) ABSTRACT

Secured transport protocols normally measure the round-trip delay in order to derive therefrom when messages should be repeated. Typical examples of such secured transport protocols are Transmission Control Protocol, according to IETF RFC 793 and Stream Control Transmission Protocol, according to IETF RFC 2960. An inference about the one-way delay from the determined round-trip delay is generally not possible. If multiple message paths exist for a transmitter to transmit the messages to the receiver, then it can be advantageous to send the messages via that message path which transmits the message to the receiver the quickest. Thus the transmitter must have available information on which message path is the quickest. According to the invention, a clock synchronisation of the transmitter and the receiver is not necessary for the above. The invention is based on the principle that, in order to determine the fastest message path the absolute delay times for the various message paths need not be known, but that it is sufficient to transmit a message on each path under evaluation and to determine the fastest message path, by means of the sequence of receipt.

### CROSS REFERENCE TO RELATED APPLICATIONS

This application is the US National Stage of International Application No. PCT/EP02/11013, filed Oct. 1, 2002 and claims the benefit thereof. The International Application claims the benefits of European application No. 01126009.8 filed Oct. 31, 2001, both of the applications are incorporated by reference herein in their entirety.

### FIELD OF INVENTION

The invention relates to a method, receiving device, and transmitting device for determining the fastest message path without clock synchronization.

### BACKGROUND OF INVENTION

Secured transport protocols normally measure the round-trip delay, which is to say the overall delay occurring when a message is transmitted from a transmitter to a receiver and when a further message, such as a confirmation message, is transmitted from the receiver to the transmitter, in order to derive therefrom when messages have to be repeated. Typical examples of such secured transport protocols are Transmission Control Protocol TCP according to IETF RFC 793 and Stream Control Transmission Protocol SCTP according to IETF RFC 2960.

To measure said round-trip delay, the transmit time of a message is noted in the transmitter and the receive time of a confirmation message arriving from the recipient of the transmitted message is determined. The round-trip delay is determined from the difference between said times. No clock synchronizing is required for this method.

Since, however, the messages can be transmitted from the transmitter to the receiver on message paths different from those on which the confirmation messages are transmitted from the receiver to the transmitter, the determined value of the round-trip delay allows no inferences to be made about the one-way delays from the transmitter to the receiver and vice versa. The determined value of the round-trip delay allows no inferences to be made about the one-way delays from the transmitter to the receiver and vice versa even when the messages are transmitted from the transmitter to the receiver on the same message path as that on which the confirmation messages are transmitted from the receiver to the transmitter as the message path can be highly asymmetric.

If multiple message paths exist for a transmitter for transmitting the messages to a receiver, then it can be advantageous to send the messages on that message path on which they are transmitted to the receiver the quickest. For this, information must be available to the transmitter as to which message path is the quickest. The fastest message path can be determined using the one-way delays of all message paths from the transmitter to the receiver.

Known solutions for measuring the one-way delays require clock synchronism of the clocks or, as the case may be, clock generators of the transmitter and receiver. Clock synchronism here means that the clocks or, as the case may be, clock generators run at the same rate but without necessarily also having the same absolute times. If clock synchronism is present, any message, or a message specially provided for test purposes and furnished by the transmitter with a time stamp is sent from the transmitter to the receiver. The one-way delay for the relevant message path can be ascertained by the receiver from the difference between the time of reception and the time stamp. In order to ascertain which path from among a number of existing message paths is the fastest, the method must be suitably repeated for all message paths. By comparing the one-way delays ascertained by the receiver for all the message paths, the fastest message path can be easily identified in the receiver and signaled to the transmitter.

Clock synchronism between the transmitter and receiver does not, however, exist in many cases.

### SUMMARY OF INVENTION

The object of the present invention is to improve the known methods, receiving devices, and transmitting devices for determining the fastest message path.

Said object is achieved by means of the features of claims 1, 9, and 15.

Preferred embodiments are the subject of the dependant claims.

A major advantage of the method according to the invention lies in not requiring clock synchronism of the transmitter and receiver for ascertaining the fastest message path between the transmitter and receiver. The underlying principle is that in order to ascertain the fastest message path it is not necessary to know the absolute delay times on the various message paths but that it instead suffices to transmit a message on each of several message paths under investigation and to determine the fastest message path by means of the sequence of reception.

According to an advantageous development of the method it is also possible to ascertain, alongside the fastest message path, the relative message propagation times, which is to say the delays caused by each individual message path compared to the fastest message path claim 2. This can be applied to, for example, distributing the load between two or more message paths if the propagation times of the message paths differ only slightly, which is to say the ascertained relative propagation times of said message paths, referred to the fastest message path, are adequately short.

The messages sent by the transmitter for determining the fastest message path or, as the case may be, for measuring the relative propagation times are advantageously sent simultaneously or a very short time apart—claim 4. If the communication protocol and/or transmitting device employed do/does not provide for the simultaneous sending of messages on multiple message paths, it can be provided for said messages to be sent a very short time apart.

### BRIEF DESCRIPTION OF THE DRAWINGS

The method according to the invention is explained in more detail below with the aid of two drawings.

FIG. 1 shows a receiving device E and a transmitting device S as well as three messages sent between the receiving device E and the transmitting device S over three different message paths P1, P2, P3 from the transmitting device S to the receiving device E at time T0, said messages being received by the receiving device E at different times T1, T2, T3. Also shown are the relative message propagation times ΔT2, ΔT3 of the message paths P2, P3 referred to the fastest message path P1.

FIG. 2 shows the receiving device E and the transmitting device S as well as a request message DelayReq sent by the receiving device E to the transmitting device S and three identical confirmation messages DelayRes sent thereupon at time T0 by the transmitting device S to the receiving device E on the three different message paths P1, P2, P3, said messages being received by the receiving device E at different times T1, T2, T3.

### DETAILED DESCRIPTION OF INVENTION

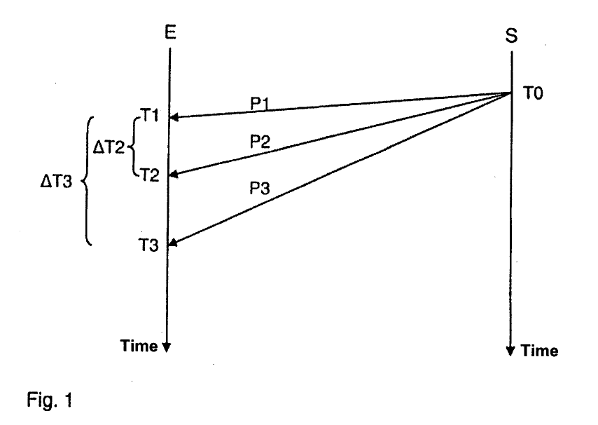

FIG. 1 illustrates the principle underlying the method according to the invention. The aim is to ascertain which of several available message paths P1, P2, P3 between the transmitting device S and the receiving device E is the fastest. The transmitting device S sends a message to the receiving device E on several message paths P1, P2, P3. The fastest message path P1 can be determined by the receiving device E by means of the sequence of reception. The absolute time of reception T1 and the absolute delay time between the transmitting device S and the receiving device E, expressed by the formula T1-T0, is of no significance here. All that is important is that the first of the identical messages sent simultaneously, or sent spaced a negligibly short time apart, was received over the first message path P1. The first message path P1 has thus been determined as being the fastest message path.

On the basis of the time differences between receipt of the identical messages over the different message paths P1, P2, P3 it is moreover possible to ascertain the relative differences in propagation time ΔT2, ΔT3, which is to say the delay times occurring on all message paths P2, P3 compared to the fastest message path P1. Expressed as a formula, the relative difference in propagation time ΔT2 for the message path P2 is: ΔT2=T2-T1. For the message path P3, the relative difference in propagation time ΔT3 is obtained according to the following formula: ΔT3=T3-T1. The relative propagation time ΔT1 of the fastest message path P1 represents a special case. It can be expedient, depending on the application, to set the relative propagation time ΔT1 of the fastest message path P1 to zero: ΔT1=0—not shown. If the relative message propagation times ΔT1, ΔT2, ΔT3 are transmitted to the transmitting device S, it will have been ensured that the transmitting device S recognizes the fastest message path P1 without the need to signal this separately.

In order to determine the fastest message path P1 or, as the case may be, relative message propagation times, the receiving device E only needs to be able to recognize that the messages were sent at the same time. This can be derived from, for instance, a time stamp in the messages, a specific message type with sequence numbers, or simply from the protocol itself.

When the fastest message path has been determined by the receiving device E, it is only necessary to signal to the transmitting device which message path is the fastest and is to be used henceforth for transmitting messages from the transmitting device S to the receiving device E.

If the communication relationship is bi-directional, then the described method will be employed independently in both directions—not shown.

Message elements embedded in customary messages, notifications or parameters can be used instead of complete messages in order to implement the method according to the invention. A request message element DelayReq will then be used instead of a separate request message DelayReq. Either the already cited confirmation messages DelayRes can be sent as a reply, or a different message type will be used in which an appropriate confirmation message element DelayRes is embedded.

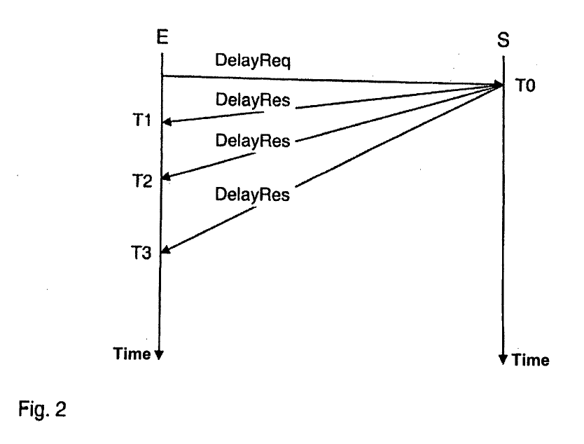

The method according to the invention can be advantageously applied with the Stream Control Transmission Protocol SCTP according to IETF RFC 2960. This is shown schematically in FIG. 2. SCTP is a multi-link protocol. As is customary with SCTP, it is assumed in the following that a message path to the distant end is identified to said distant end by means of an Internet Protocol address (referred to in the following as ‘IP address’).

It is further assumed that a part of the expansions which are described in IETF Internet Draft draft-ietf-tsvwg-addip-sctp-02 has been implemented. It is possible with this part for an SCTP endpoint E to set the primary path or, as the case may be, primary message path of a communication partner S, meaning that E can determine on which path the communication partner S sends messages to the endpoint E. This expansion is used for signaling which message path is the fastest.

An SCTP message consists of a common header and a number of chunks. Said number of chunks can vary with different SCTP messages; the use of messages without chunks is also permissible. Each chunk is classified by a chunk type—a number between 0 and 255. The method described here uses special new chunk types (DelayReq(SN), DelayRes(SN)) with a sequence number SN. SCTP allows such expansions. In doing this it is possible to maintain interoperability with SCTP endpoints for which said new chunks have not been implemented. The receiving device E sends out a request message DelayReq(SN) in order to initiate a measurement. SN+1 is used as the sequence number for the next measurement, which is to say that an additional counter is maintained by the receiving device E. If a request message DelayReq(SN) is received by the transmitting device S, then in each case one confirmation message DelayRes(SN) will be sent on some or all available message paths P1, P2, P3. The receiving device E will then be able to ascertain which message path P1, P2, P3 is the fastest. The fastest message path P1 is specified by the destination IP address of the confirmation message which contains the DelayRes(SN) chunk and is received first. Said IP address will then be signaled with the message “Set Primary IP Address” (described in 3.2.5 and 4.4 of the cited IETF Internet Draft draft-ietftsvwg-addip-sctp02, reproduced in extract form below) to the transmitting device S, which will thereupon always use said message path P1 as the first message path for transmitting data. The frequency of said measurements depends on the stability of the network. An available possible option is, however, to perform such measurements periodically.

As an alternative to the above described method employing DelayReq and DelayRes chunks it is also possible to use the Heartbeat and Heartbeat-Ack chunk in order to determine the fastest message path P1, P2, P3. In response to the reception of a Heartbeat chunk, Heartbeat-Ack chunks will then be sent on some or all message paths instead of the DelayRes chunks in the above exemplary embodiment. This method also ensures interoperability with other implementations. It is moreover advantageously possible to dispense with introducing new chunk types, although it must be added that the behavior of the protocol will have to be adjusted correspondingly.

Extract from IETF Internet Draft draft-ietf-tsvwg-addip-sctp-02

| | | |
|---|---|---|
| Internet Draft | draft-ietf-tsvwg-addip-sctp-02 | June 2001 |
| Network Working Group | | R. R. Stewart |
| NTERNET DRAFT | | M. A. Ramalho |
| | | Cisco Systems |
| | | Q. Xie |
| | | Motorola |
| | | M. Tuexen |
| | | Siemens AG |
| | | I. Rytina |
| | | Ericsson |
| | | P. Conrad |
| | | Temple University |
| expires in six months | | Jun. 29, 2001 |

SCTP Extensions for Dynamic Reconfiguration of IP Addresses
and Enforcement of Flow and Message Limits
<draft-ietf-tsvwg-addip-sctp-02.txt>

```
  (...)
        3.2.5 Set Primary IP Address

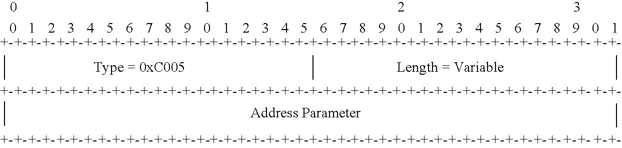

        Address Parameter: TLV
        This field contains an IPv4 or IPv6 address parameter as described in
        3.3.2.1 of [RFC2960]. The complete TLV is wrapped within this parame-
        ter. It requests the receiver to mark the specified address as the pri-
        mary address to send data to (see section 5.1.2 of [RFC2960]). The re-
        ceiver MAY mark this as its primary upon receiving this request.
        An example TLV requesting that the IPv4 address 10.1.1.1 be made the
        primary destination address would look as follows:

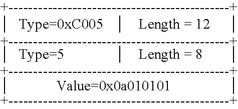

        Valid Chunk Appearance
        The Set Primary IP Address parameter may appear in the ASCONF chunk,
        the INIT, or the INIT-ACK chunk type. The inclusion of this parameter
        in the INIT or INIT-ACK can be used to indicate an initial preference
        of primary address.
  (...)
4.4 Setting of the primary address
        A sender of this option may elect to send this combined with a deletion
        or addition of an address. A sender SHOULD only send a set primary re-
        quest to an address that is already considered part of the association.
        In other words if a sender combines a set primary with an add of a new
        IP address the set primary will be discarded unless the add request is
        to be processed BEFORE the set primary (i.e. it precedes the set pri-
        mary).
        A request to set primary MAY also appear in an INIT or INIT-ACK chunk.
        This can give advice to the peer endpoint as to which of its addresses
        the sender of the INIT or INIT-ACK would like to be used as the primary
        address.
        The request to set an address as the primary path is an option the re-
        ceiver SHOULD perform. It is considered advice to the receiver of the
        best destination address to use in sending SCTP packets (in the re-
        quester's view). If a request arrives that asks the receiver to set an
        address as primary that does not exist, the receiver should NOT honor
        the request, leaving its existing primary address unchanged.
```

1.-19. (cancelled)

20. A method for determining the fastest message path in a communication system having a transmitting device, a receiving device, and at least two message paths from the transmitting device to the receiving device, the method comprising:
sending messages and/or message elements by the transmitting device via all message paths from the transmitting device to the receiving device; and
determining the fastest message path as being the message path via which the message and/or message element received first at the receiving device.

21. A method according to claim 20, wherein all messages or message elements sent by the transmitting device are received by the receiving device on the message paths from the transmitting device to the receiving device and relative message propagation times are ascertained for all or for selected message paths from the times separating the messages or message elements received on the different message paths referred to the message propagation time of the fastest message path.

22. A method according to the claim 20, wherein the ascertained fastest message path and/or the relative message propagation times of all or of selected message paths are signaled to the transmitting device by the receiving device.

23. A method according to claim 20, wherein the messages or message elements are sent by the transmitting device via the different message paths from the transmitting device to the receiving device simultaneously or spaced only slightly apart by a length of time which is negligible compared to the expected propagation time.

24. A method according to claim 20, wherein messages or message elements of the same length and/or messages having the same features are sent by the transmitting device via the different message paths from the transmitting device to the receiving device.

25. A method according to claim 20, wherein the messages or message elements transmitted via the different message paths from the transmitting device to the receiving device are recognized by a time stamp applied by the transmitting device as being the messages or message elements provided for ascertaining the fastest message path and/or relative message propagation times of all or of selected message paths.

26. A method according to claim 20, wherein the messages or message elements transmitted via the different message paths from the transmitting device to the receiving device are recognized by a special message type provided for this in a communication protocol agreed between the transmitting device and receiving device as being the messages or message elements provided for ascertaining the fastest message path and/or relative message propagation times of all or of selected message paths.

27. A method according to claim 20, wherein the messages or message elements transmitted via the different message paths from the transmitting device to the receiving device are recognized by a sequence number of the messages or message elements set by the transmitting device as being the messages or message elements provided for ascertaining the fastest message path and/or relative message propagation times of all or of selected message paths.

28. A method according to claim 20, wherein the messages or message elements transmitted via the different message paths from the transmitting device to the receiving device are recognized by features of the communication protocol agreed between the transmitting device and receiving device as being the messages or message elements provided for ascertaining the fastest message path and/or relative message propagation times of all or of selected message paths.

29. A method according to claim 20, wherein the messages or message elements transmitted via the different message paths from the transmitting device to the receiving device are recognized by:
a time stamp applied by the transmitting device;
a special message type provided for this in a communication protocol agreed between the transmitting device and receiving device;
a sequence number of the messages or message elements set by the transmitting device; and
features of the communication protocol agreed between the transmitting device and receiving device as being the messages or message elements provided for ascertaining the fastest message path and/or relative message propagation times of all or of selected message paths.

30. A method according to claim 20, wherein a multi-link protocol in the case of which a primary message path from among different message paths can be signaled by the receiving device to the transmitting device, said primary message path then being used by the transmitting device for transmitting messages to the receiving device, is employed as the communication protocol between the transmitting device and receiving device.

31. A method according to claim 20, wherein the Stream Control Transmission Protocol SCTP according to IETF RFC 2960 with an expansion by means of which the receiving device can signal to the transmitting device a primary message path to be used for transmitting messages to the receiving device is employed as the communication protocol between the transmitting device and receiving device.

32. A receiving device for receiving messages from a transmitting device and coupled to a transmitting device via at least two message paths, comprising a mechanism for determining the fastest message path from the transmitting device to the receiving device by means of which the receiving device receives messages or message elements sent from the transmitting device via all message paths from the transmitting device to the receiving device and determines the fastest message path as being the message path via which the receiving device first receives a message.

33. A receiving device according to claim 32, comprising a mechanism for determining relative message propagation times for all or for selected message paths from the length of time which the messages and/or message elements received from the transmitting device via all message paths are spaced apart, with the relative message propagation times being referred to the message propagation time of the fastest message path.

34. A receiving device according to claim 32, wherein the receiving device comprises a mechanism for signaling the fastest message path and/or relative message propagation times to the transmitting device.

35. A receiving device according to claim 32, wherein the receiving device comprises a mechanism for identifying the messages or message elements provided for ascertaining the fastest message path and/or relative message propagation times of all or of selected message paths, the mechanism uses:
a time stamp applied by the transmitting device;
a special message type provided for this in the communication protocol agreed between the transmitting device and receiving device;
a sequence number of the messages or message elements set by the transmitting device; and
the features of the communication protocol agreed between the transmitting device and receiving device.

36. A receiving device according to claim 32, wherein the receiving device comprises a protocol device forming the receiver part of a multi-link protocol, wherein
the multi-link protocol providing a mechanism for signaling of a primary message path from among different message paths by the receiving device to the transmitting device, and wherein
the primary message path being used by the transmitting device for transmitting messages to the receiving device.

37. A receiving device according to claim 32, wherein the receiving device comprises a protocol device forming the receiver part of the Stream Control Transmission Protocol SCTP according to IETF RFC 2960, wherein
the Stream Control Transmission Protocol SCTP having an expansion by means of which the receiving device can signal to the transmitting device a primary message path to be used for transmitting messages to the receiving device.

38. A transmitting device for sending messages to a receiving device and coupled to the receiving device via at least two message paths, the transmitting device comprising:
a mechanism for simultaneously sending messages or message elements via all message paths; and
a mechanism for identifying the messages or message elements so that the messages or message elements can be recognized by the receiving device as being the messages or message elements provided for determining the fastest message path and/or relative message propagation times of all or of selected message paths.

39. A transmitting device according to claim 38, wherein the transmitting device having a mechanism for sending messages or message elements of the same length and/or messages or message elements having the same features for determining the fastest message path and/or relative message propagation times of all or of selected message paths by the receiving device.

40. A transmitting device according to claim 38, wherein the mechanism for identifying the messages or message elements comprises a mechanism for applying a time stamp and/or a mechanism for using a message type provided in the communication protocol agreed between the transmitting device and receiving device for ascertaining of the fastest message path and/or relative message propagation times of all or of selected message paths by the receiving device and/or comprise features of the communication protocol agreed between the transmitting device and receiving device.

41. A transmitting device according to claim 38, comprising a protocol device forming the transmitter part of a multi-link protocol, wherein
the multi-link protocol providing a mechanism for signaling of a primary message path from among different message paths by the receiving device to the transmitting device, and wherein
the primary message path being used by the transmitting device for transmitting messages to the receiving device.

42. A transmitting device according to claim 38, comprising a protocol device forming the transmitter part of the Stream Control Transmission Protocol SCTP according to IETF RFC 2960, wherein the Stream Control Transmission Protocol SCTP having an expansion by means of which the receiving device can signal to the transmitting device a primary message path to be used for transmitting messages to the receiving device.

43. A transmitting device for sending messages to a receiving device and coupled to the receiving device via at least two message paths, the transmitting device comprising:
a mechanism for sending messages or message elements via all message paths spaced only slightly apart by a length of time which is negligible compared to the expected propagation time; and
a mechanism for identifying the messages or message elements so that the messages or message elements can be recognized by the receiving device as being the messages or message elements provided for determining the fastest message path and/or relative message propagation times of all or of selected message paths.
